(19) United States
(12) Patent Application Publication
(10) Pub. No.: US 2025/0369925 A1
(43) Pub. Date: Dec. 4, 2025

(54) DEVICE AND METHOD FOR FLOOR MATERIAL CLASSIFICATION

(71) Applicant: KOREA UNIVERSITY RESEARCH AND BUSINESS FOUNDATION, Seoul (KR)

(72) Inventors: Youngsu CHA, Seoul (KR); Jiyong MIN, Seoul (KR)

(21) Appl. No.: 19/218,028

(22) Filed: May 23, 2025

(30) Foreign Application Priority Data
May 28, 2024 (KR) 10-2024-0069298

(51) Int. Cl. G01N 29/12; G01N 29/34; G01N 29/44

(52) U.S. Cl. CPC G01N 29/12; G01N 29/348; G01N 29/4454

(57) ABSTRACT

Disclosed is a floor material recognition system and method. The floor material recognition system may include a control unit configured to control an operation of the floor material recognition system; and an object recognition device configured to generate a mechanical vibration in response to an actuator signal received from the control unit and to generate a sensor signal corresponding to the mechanical vibration, and the control unit may recognize a material on the floor surface present in a movement path of the floor material recognition system based on the sensor signal.

### CROSS-REFERENCE TO RELATED APPLICATION(S)

This application claims the benefit under 35 USC § 119 (a) of Korean Patent Application No. 10-2024-0069298 filed on May 28, 2024 in the Korean Intellectual Property Office, the entire disclosure of which is incorporated herein by reference for all purposes.

### BACKGROUND

### 1. Field

The present invention relates to a floor material recognition technique, and more particularly, to a device and method for recognizing or classifying materials of the floor surface using an objection recognition device attached to the bottom of a mobile robot and acquiring sensor data during movement of the mobile robot.

### 2. Description of Related Art

Robots for household and daily tasks are attracting increasing attention due to their convenience and technological development. In particular, a mobile robot provides safe and stable services by moving around and performing tasks, such as cleaning and delivery. To appropriately accomplish these tasks, the mobile robot needs to recognize surrounding environments in detail. Also, the mobile robot requires more specific information on the floor to prevent accidents, such as drops or slips. Therefore, it is necessary to construct an external environment recognition system that utilizes a sensor to recognize surrounding environments, the floor terrain, or floor materials.

As an example, in Korean Patent Laid-Open Publication No. 2011-0109705 (published on Oct. 6, 2011), the surface condition of the floor surface is detected based on intensity of infrared (IR) signals detected by a plurality of light receiving elements during a set detection period of time using an IR light emitting element and the plurality of light receiving elements and an intensity ratio. However, it uses the plurality of light receiving elements and is sensitive to temperature, so may malfunction when used indoors.

To reduce this sensitivity to temperature, in Korean Patent Laid-Open publication No. 2017-0026857 (published on Mar. 9, 2017), a laser distance sensor is used to detect a relatively small floor obstacle present in a movement path of a mobile robot and to more safely secure an available driving area of the mobile robot. However, the laser distance sensor is effective in observing the floor terrain, but may not determine a floor material. Also, to utilize a laser sensor, the floor and the robot need to be separate from each other by at least a certain distance, so a size of the mobile robot needs to be large.

Therefore, there is a need for the development of a floor material recognition system that may determine a floor material while being less affected by surroundings and may reduce the overall size of a robot.

### SUMMARY

A technical subject to be achieved by the present invention is to provide a floor material recognition device and method that allows a mobile robot to independently determine a floor material while moving to select a driving method or a cleaning tool.

A floor material recognition system according to an example embodiment of the present invention may include a control unit configured to control an operation of the floor material recognition system; and an object recognition device configured to generate a mechanical vibration in response to an actuator signal received from the control unit and to generate a sensor signal corresponding to the mechanical vibration, and the control unit may recognize a material on the floor surface present in a movement path of the floor material recognition system based on the sensor signal.

According to a floor material recognition device and method according to an example embodiment of the present invention, it is possible to classify a floor material using a mechanical signal generated from an actuator portion of an object recognition device and an electrical signal generated through high frequency.

Also, since it is possible to implement a system including all of a main board equipped with an artificial neural network, a sensor board that operates an object recognition device, and a control board that is involved in driving, a mobile robot may independently determine a floor material while driving.

Also, the overall size of a mobile robot may be reduced by using an object recognition device to reduce a distance between a sensor and the floor.

Also, since the size of data acquired by an object recognition device is one-dimensional voltage data, a faster operation is possible than when two-dimensional or three-dimensional visual data is input to machine learning as input data.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a floor material recognition system equipped with an object recognition device according to an example embodiment of the present invention;

FIG. 2A is an exploded perspective view of the object recognition device included in the floor material recognition system shown in FIG. 1;

FIG. 2B illustrates an actuator and a sensor included in the object recognition device shown in FIG. 2A;

FIG. 3A is a perspective view of a fixing device to which the object recognition device shown in FIG. 2A is coupled;

FIG. 3B is a perspective view of the fixing device shown in FIG. 3A viewed from below;

FIG. 3C is a side view of the fixing device shown in FIG. 3A;

FIG. 3D is a side view of the fixing device shown in FIG. 3A that operates in contact with the floor;

FIG. 4 is a functional block diagram of the floor material recognition system shown in FIG. 1;

FIG. 5 illustrates an implementation example of the floor material recognition system shown in FIG. 4;

FIG. 6 illustrates a prototype of the floor material recognition system shown in FIG. 4;

FIG. 7 illustrates a case in which no contact is made with six floor materials selected to conduct a floor material identification test with a test execution method according to an example embodiment of the present invention;

FIG. 8 illustrates an exemplary structure of a floor material recognition model according to an example embodiment of the present invention;

FIG. 9A is a graph showing sensor data acquired from an object recognition device as a change in voltage over time according to an example embodiment of the present invention;

FIG. 9B is a graph showing data processed after converting a change in voltage over time acquired from an object recognition device into a frequency domain according to an example embodiment of the present invention;

FIG. 10 illustrates graphs each showing sensor data and frequency spectrum according to each floor material used in an artificial neural network model according to an example embodiment of the present invention;

FIG. 11 is a graph showing a classification confusion matrix of a trained artificial neural network model according to an example embodiment of the present invention; and

FIG. 12 is a photo showing an example in which a trained floor material recognition model is mounted to a floor material recognition system and an actual mobile robot determines a floor material while driving according to an example embodiment of the present invention.

### DETAILED DESCRIPTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Hereinafter, example embodiments will be described with reference to the accompanying drawings. However, the scope of the patent application is not limited to or restricted by such example embodiments. Like reference numerals used herein refer to like elements throughout.

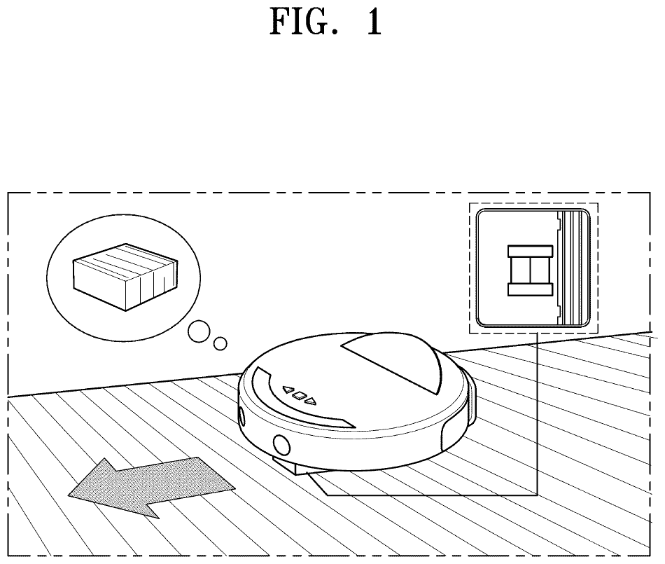

FIG. 1 illustrates a floor material recognition system equipped with an object recognition device according to an example embodiment of the present invention.

Referring to FIG. 1, the floor material recognition system, which may also be referred to as a floor material recognition device, a floor material classification device, a floor material classification system, and the like, may also be implemented as a robot cleaner. According to example embodiments of the present invention, the floor material recognition system may independently recognize (or classify) a floor material while the floor material recognition system, such as the robot cleaner, is moving. However, the scope of the present invention is not limited to an implementation example of the floor material recognition system, and the floor material recognition system may be implemented in various forms depending on example embodiments.

In particular, the object recognition device is (fixedly) mounted at the bottom of the floor material recognition system to recognize a material on the floor surface (or ground) and to control an operation of the floor material recognition system, such as a selection of a driving method or a cleaning task, based on recognition results.

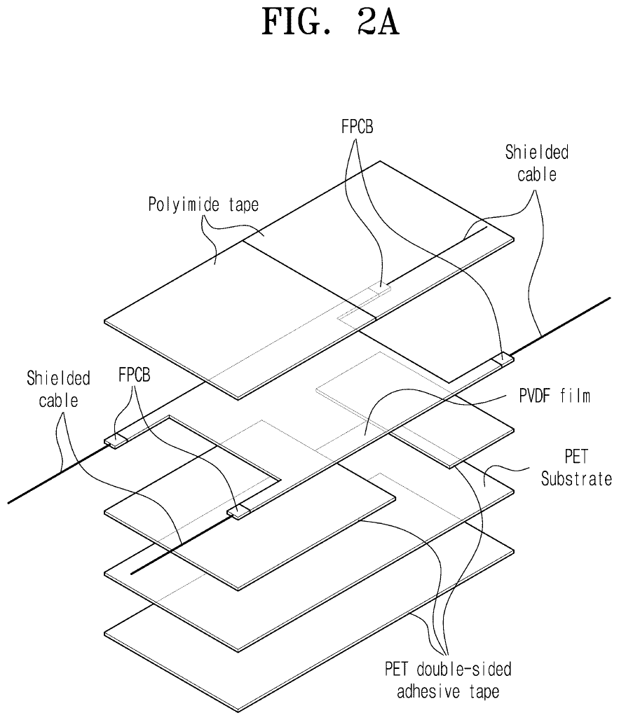

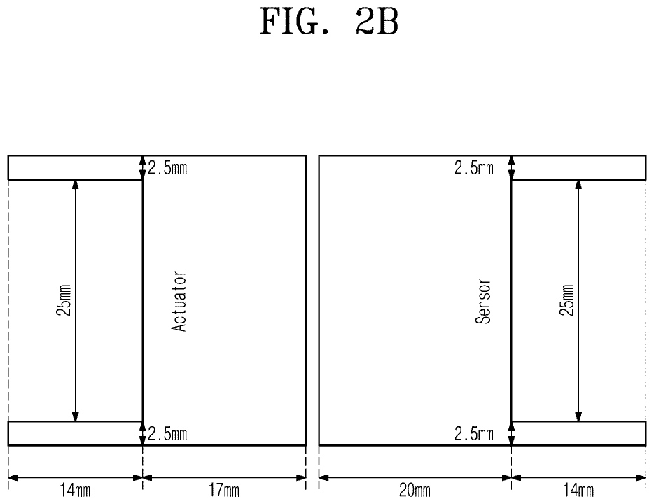

FIG. 2A is an exploded perspective view of the object recognition device included in the floor material recognition system shown in FIG. 1, and FIG. 2B illustrates an actuator and a sensor included in the object recognition device shown in FIG. 2A.

Initially, the object recognition device according to an example embodiment of the present invention is based on an object recognition device described in Korean Patent Registration No. 2371459 (announced on Mar. 8, 2022) in which the inventor of the present invention is listed as the inventor. Therefore, detailed description related to the object recognition device may refer to the disclosure of the registered patent.

The object recognition device may include a substrate, an actuator and a sensor formed on the substrate, and a protective film formed on the actuator and the sensor.

The substrate is a component configured to fix (or mount) the actuator and the sensor and, according to an example embodiment, may be a polyethylene terephthalate (PET) substrate. One surface of the substrate may be mounted (or installed) on a fixing device described below. According to an example embodiment, the substrate may be (fixedly) coupled to the fixing device through a coupling means such as a double-sided tape (e.g., PET double-sided adhesive tape). According to an example embodiment, the substrate may be implemented to have the length of 65 mm and the width of 30 mm. However, the scope of the present invention is not limited to the shape or dimensions of the substrate, and the shape or the dimensions may be changed depending on example embodiments.

The actuator and the sensor are provided on the other surface of the substrate (, which indicate the surface opposite to one surface that is coupled to the fixing device). According to an example embodiment, at least a portion of the actuator and at least a portion of the sensor may be (fixedly) coupled to the substrate through a coupling means, such as a double-sided tape (e.g., PET double-sided adhesive tape).

According to an example embodiment, the actuator and the sensor may be implemented in the same or similar shape. Here, the actuator and the sensor may be provided to be symmetrical based on the center line in the widthwise direction of the substrate and then, may be attached to the substrate.

The actuator and the sensor may be implemented using a piezoelectric member such as a polyvinylidene fluoride (PVDF) film. That is, as shown in FIG. 2B, the actuator and the sensor may be manufactured by cutting the PVDF film. Also, the actuator and the sensor may have a film size that allows a vibration generated from the actuator to be transmitted to the sensor and the sensor to receive an ambient signal, such that a signal may be identified depending on a floor material. That is, the actuator generates the vibration by a sinusoidal voltage, and the sensor receives the vibration generated from the actuator and generates voltage by the piezoelectric effect.

The actuator includes a body in a (roughly) rectangular shape and at least one extension formed to extend from the body. According to an example embodiment, two extensions may be provided. The extension may be formed to extend in the longitudinal direction of the body, and the actuator may have an overall (roughly) “flattened-U” shape. Also, the extensions each with predetermined width may be formed to extend in the longitudinal direction of the actuator from both ends of one side of the body of the actuator (, which indicates the side opposite to the side that is in contact with the sensor). That is, the actuator may be understood as a (roughly) rectangular piezoelectric member having a cutting line on one side (side opposite to the side that faces the sensor). In the example embodiment of FIG. 2B, the body of the actuator may be implemented to have the length of 17 mm and the width of 30 mm, and the extension may be implemented to have the length of 14 mm and the width of 2.5 mm. Alternatively, the actuator may be understood as the piezoelectric member having the length of 31 mm and the width of 30 mm, with the cutting line having the length of 14 mm and the width of 25 mm formed on one side. However, the scope of the present invention is not limited to the detailed shape or dimensions of the actuator and, depending on example embodiments, the shape or the dimensions of the actuator may be changed.

An electrode may be formed on each of the extensions of the actuator. The electrode may be formed through a (flexible) printed circuit board (FPCB) and the like. That is, the flexible printed circuit board (FPCB) that forms the electrode may be attached at the end of the extension. A signal transmission means, for example, a wire and a cable (shielded cable) for transmitting and receiving signals (or data) may be attached to the electrode. Therefore, actuator signals may be provided through two electrodes of the actuator. However, the scope of the present invention is not limited to a signal transmission method, and signals or data may be transmitted and received using a wireless communication method depending on example embodiments.

The sensor includes a body in a (roughly) rectangular and at least one extension formed to extend from the body. According to an example embodiment, two extensions may be provided. The extension may be formed to extend in the longitudinal direction of the body, and the actuator may have an overall (roughly) “flattened-U” shape. Also, the extensions each with predetermined width may be formed to extend in the longitudinal direction of the sensor from both ends of one side of the body of the sensor (, which indicates the side opposite to the side that is in contact with the actuator). That is, the sensor may be understood as a (roughly) rectangular piezoelectric member having a cutting line on one side (side opposite to the side that faces the actuator). In the example embodiment of FIG. 2B, the body of the sensor may be implemented to have the length of 20 mm and the width of 30 mm, and the extension may be implemented to have the length of 14 mm and the width of 2.5 mm. Also, the sensor may be understood as the piezoelectric member having the length of 31 mm and the width of 30 mm, with the cutting line having the length of 14 mm and the width of 25 mm formed on one side. However, the scope of the present invention is not limited to the detailed shape or dimensions of the sensor and, depending on example embodiments, the shape or the dimensions of the sensor may be changed.

An electrode may be formed on each of the extensions of the sensor. The electrode may be formed through a (flexible) printed circuit board (FPCB) and the like. That is, the flexible printed circuit board (FPCB) that forms the electrode may be attached at the end of the extension. Through this, sensor data that is voltage data may be acquired through two electrodes.

The actuator and the sensor may be provided such that their bodies are in contact with each other (or are spaced part by a predetermined distance or overlap by a predetermined area). Also, at least a portion of the actuator and the sensor may be fixedly coupled to the substrate. In detail, only the extensions of the actuator (or only extensions and portion of the body) may be fixed to the substrate through a coupling means such as a double-sided tape. That is, in the body of the actuator, a portion corresponding to the predetermined length from the surface in contact with the sensor may not be fixed to the substrate. This is to facilitate the vibration of the actuator. That is, vibration generation may be made easier by not fixing, to the substrate, at least a portion of the body in which vibration occurs. However, since the body of the sensor does not generate a vibration, the entire (or at least a portion of) sensor may be fixedly attached to the substrate.

Also, the shape of the extensions provided to the actuator and the sensor may prevent the electrode from being damaged in contact with the floor when the floor material recognition system is driving.

The protective film may be provided on the actuator and the sensor, to protect the actuator and the sensor (i.e., protect PVDF film) and/or to improve the performance of the actuator. Here, both the actuator and the sensor may be protected using a single protective film, or the actuator and the sensor may be protected using two protective films, respectively. However, if it is necessary to prevent the vibration generated from the actuator from being directly transmitted to the sensor, a separate protective film may be provided to each of the actuator and the sensor. The protective film may be implemented with a Kapton tape or a polyimide tape. Also, the protective film may be implemented as a single protective film having the same size as that of the substrate, or may be implemented as a first protective film having the same size as that of the actuator and a second protective film having the same size as that of the sensor. According to an example embodiment, the protective film may have a (roughly) rectangular shape, so may protect both the body and the extensions of the actuator and/or the sensor.

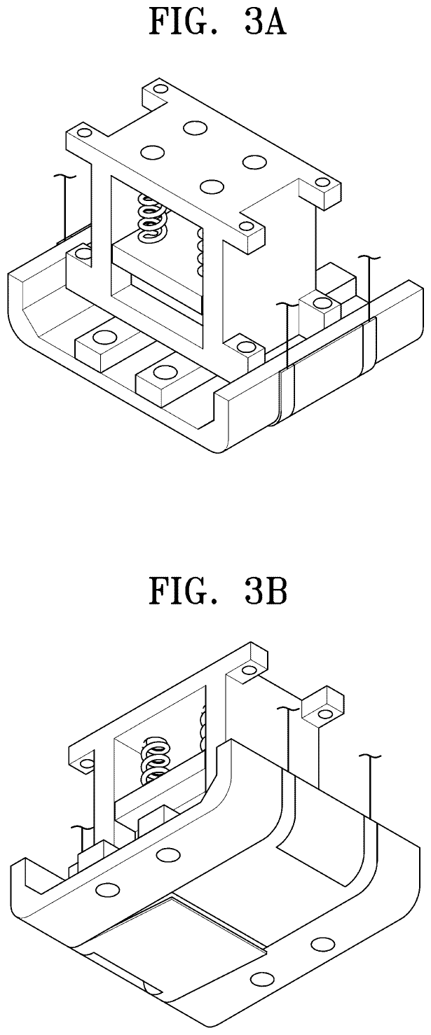

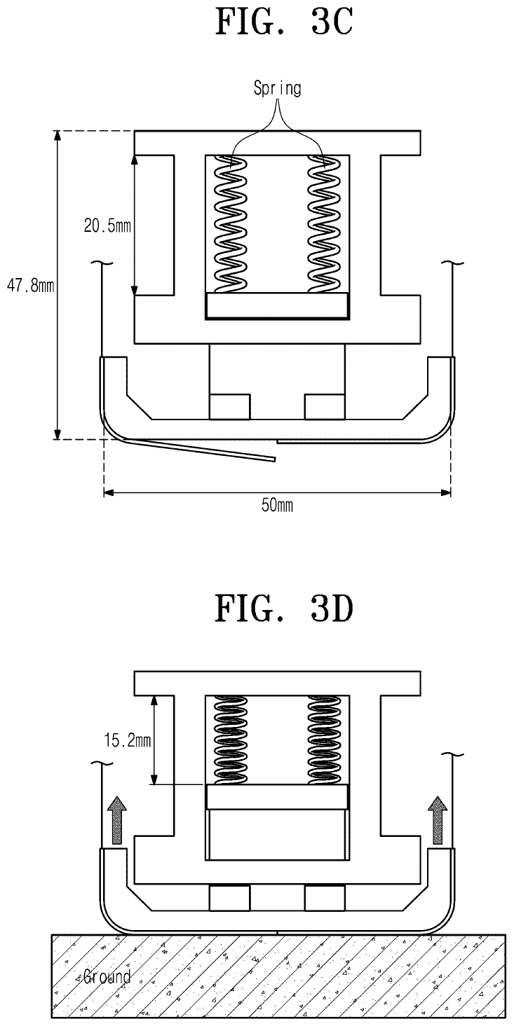

FIG. 3A is a perspective view of the fixing device to which the object recognition device shown in FIG. 2A is coupled, FIG. 3B is a perspective view of the fixing device shown in FIG. 3A viewed from below, FIG. 3C is a side view of the fixing device shown in FIG. 3A, and FIG. 3D is a side view of the fixing device shown in FIG. 3A that operates in contact with the floor.

The fixing device includes a panel to which the object recognition device is mounted, at least one elastic means of which one end is fixed to the panel, and a fixing portion to which another end of the elastic means is fixed and configured to mount a fixing means to an object recognition system.

The object recognition device may be mounted on the bottom surface of the panel. Here, since the substrate is attached on the bottom surface of the object recognition device, the protective film may face the bottom surface in a state in which the object recognition device is mounted. Also, the panel may refer to a curved panel (or curved-surface panel) of which the bottom surface is flat, but of which both ends in the longitudinal direction are rounded in the upward direction (direction opposite to floor surface). That is, the panel may represent a flattened “U”-shaped curved panel of which the bottom surface is flat. This is a configuration to prevent the electrode of the object recognition device from being damaged (or broken). Therefore, the size of the panel may be determined such that the body of the actuator and at least a portion of the body of the sensor (or the body of the actuator, at least a portion of the extension of the actuator, the body of the sensor, and at least a portion of the extension of the sensor) are mounted on the flat bottom surface of the panel. The above-described panel may be manufactured by performing 3D printing using PLA as a material.

One end of at least one elastic means, for example, a spring, may be fixed to an upper portion of the panel. Due to the elastic means, the panel or the object recognition device may make a contact with the floor surface with predetermined force (or pressure). Therefore, a stable detection signal in which an external environmental element is removed may be acquired.

The other end of the elastic means may be fixed on the bottom surface of the fixing portion. The fixing portion may be mounted (or fixed) on the bottom surface of the floor material recognition system. Here, the fixing portion may be mounted to the floor material recognition system through a fixing means, such as a screw, a piece, and a hook.

The elastic means and the fixing portion described above may also be referred to as a suspensor. The suspensor may provide elasticity to the panel such that the panel is contact with the ground (floor surface) with constant force (or pressure) at all times and/or such that the panel (or object recognition device) is not separate from the bottom surface of the floor material recognition system by at least a predetermined distance. FIG. 3C shows the height range in which the suspensor may be maximally extended (or relaxed) when it is in contact with the ground, and FIG. 3D shows the height range in which the suspensor may be maximally reduced (or contracted) when it is in contact with the ground.

However, the above-described fixing device is only an example embodiment, and the core idea of the present invention lies in the fixing device that allows the object recognition device to be in contact with the floor with certain force (or pressure) while the floor material recognition system is moving and/or stationary. That is, since the fixing means is for mounting the object recognition device to the object recognition system, so there may be various modification examples when the object recognition device or the fixing means itself is integrally manufactured with the object recognition system.

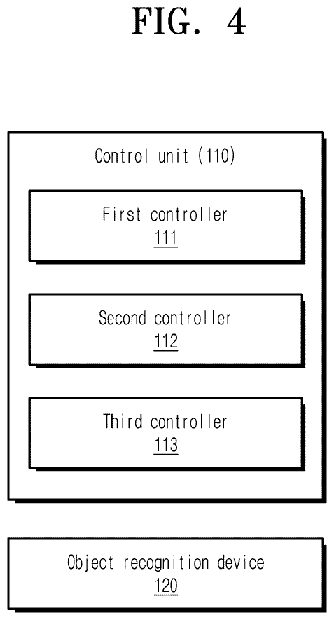

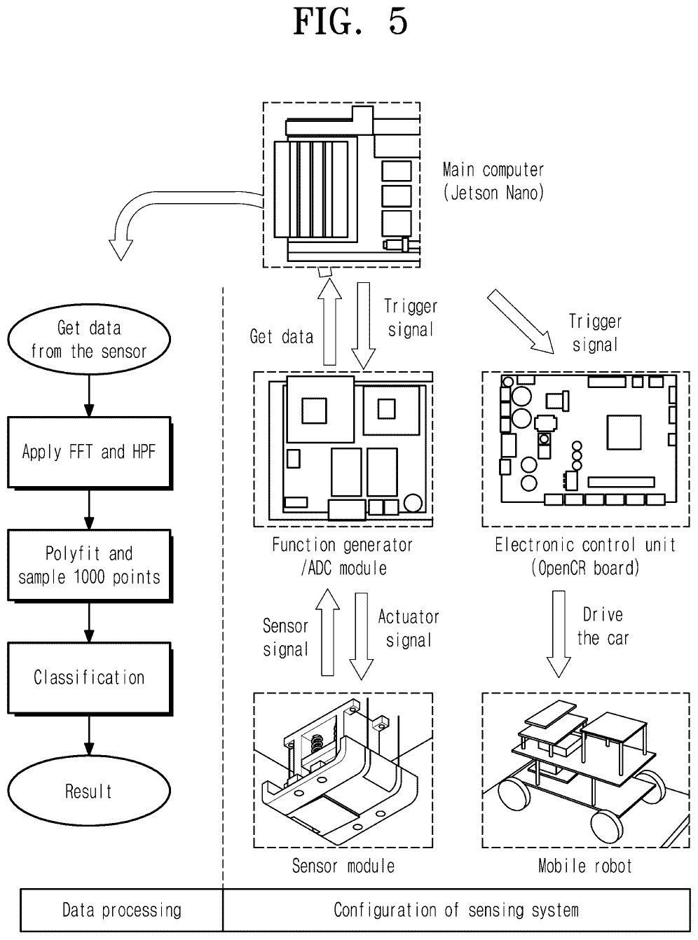

FIG. 4 is a functional block diagram of the floor material recognition system shown in FIG. 1.

Referring to FIG. 4, the floor material recognition system at least includes a control unit 110 and an object recognition device 120. The control unit 110 includes a first controller 111, a second controller 112, and a third controller 113. Depending on example embodiments, the floor material recognition system may further include a driving unit configured to provide a driving force to the floor material recognition system, and a fixing device configured to fix the object recognition device 120 to the floor material recognition system.

The control unit 110 may control the overall operation of the floor material recognition system. That is, the control unit 110 may control a floor material recognition operation of the floor material recognition system and/or a movement operation of the floor material recognition system.

That is, the control unit 110 may transmit a control signal for controlling the object recognition device 120, and may receive a sensor signal (, which may indicate voltage data,) from the object recognition device 120. In response to the control signal received from the control unit 110, the object recognition device 120 may generate a vibration, may collect a sensor signal corresponding to the vibration, and may transmit the same to the control unit 110. Therefore, the control unit 110 may recognize (or classify) a floor material based on the received sensor signal.

Also, the control unit 110 may transmit a control signal for controlling the movement of the floor material recognition system. The driving unit of the floor material recognition system may generate a driving force in response to the control signal received from the control unit 110, and the floor material recognition system may operate according to the generated driving force.

The first controller 111 may transmit a trigger signal (, which may be understood as a kind of control signal and may be referred to as a data collection signal,) to the second controller 112, and may receive a sensor signal from the second controller 112. The first controller 111 may recognize a material on the floor surface present in a movement path of the floor material recognition system based on the received sensor signal. To this end, the first controller 111 may input the acquired sensor signal to a pretrained floor material recognition model (or floor material identification model), and may recognize (or classify) a floor material based on output of the floor material recognition model. Therefore, it may be understood that the trained floor material recognition model is installed (or stored) in the first controller 111.

According to an example embodiment, the first controller 111 may perform a preprocessing operation for the received sensor signal to generate input data of the floor material recognition model. The preprocessing operation may include at least one of a transformation operation of transforming a sensor signal of a time domain to a signal of a frequency domain, a filtering operation using a predetermined filter, and a sampling operation through polyfitting.

The transformation operation may be performed through Fourier transform (FT) or fast Fourier transform (FFT). According to an example embodiment, data in the range of 0 to 2 kHz may be acquired as a result of Fourier transform. The filtering operation may be performed on the sensor signal transformed to the frequency domain. The filtering operation may be performed through a high pass filter (HPF) having a predetermined cutoff frequency. For example, a component (or signal) of an area below a predetermined frequency (e.g., 100 Hz) that is greatly affected by noise may be removed in the sensor signal transformed to the frequency domain. That is, the cutoff frequency may be 100 Hz.

The sampling operation may be performed on the filtered sensor signal. In detail, after polyfitting with an a-degree (a denoting a natural number, for example, 30-degree) polynomial, the total number of data may be reduced (or sampled) to a predetermined number (e.g., 1000) using a polyfitted graph. Through this, input data of the floor material recognition model may be generated. According to an example embodiment, data may be sampled at a predetermined frequency unit in the polyfitted graph.

In response to the trigger signal received from the first controller 111, the second controller 112 may transmit a control signal (actuator signal) for driving an actuator of the object recognition device 120 to the object recognition device 120. Vibration generated from the actuator that receives the actuator signal through an electrode and an electrical signal (sensor data) generated in response to the vibration is transmitted to the second controller 112 through a sensor. The second controller 112 may detect a sensor signal and may transmit the detected sensor signal to the first controller 111. Here, the second controller 112 may collect sensor data from the sensor at the same time of transmitting the actuator signal or sequentially at predetermined time intervals. Also, a detection operation by the second controller 112 may include a sampling operation for consecutive signals output from the sensor. The sampling operation may represent an ADC operation that converts an analog signal to a digital signal.

Meanwhile, the first controller 111 may transmit a trigger signal (, which may be understood as a control signal and may be referred to as a driving signal,) to the third controller 113. Here, the trigger signal transmitted to the third controller 113 and the trigger signal transmitted to the second controller 112 may be transmitted simultaneously or sequentially at a predetermined time interval, so sensor data may be acquired while driving. In response to the trigger signal from the first controller 111, the third controller 113 may transmit a control signal for controlling the driving unit to the driving unit. In response to the received control signal, the driving unit may generate a predetermined driving force to induce the movement of the floor material recognition system. Therefore, the third controller 113 may also be referred to as a driver that generates the control signal for controlling the driving unit.

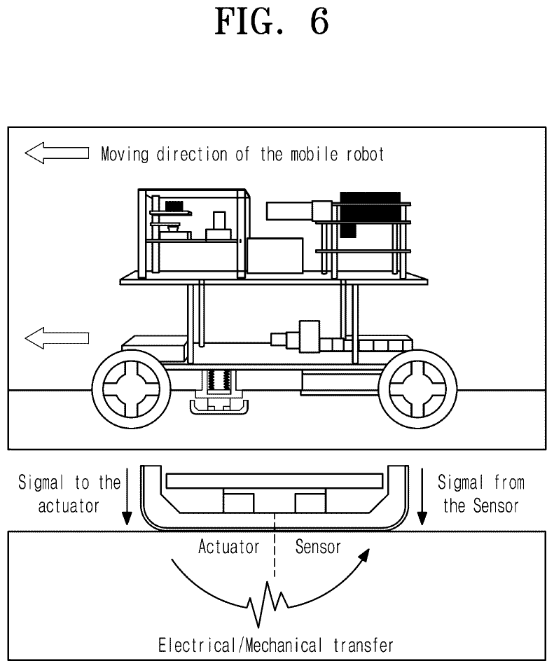

FIG. 5 illustrates an implementation example of the floor material recognition system shown in FIG. 4, and FIG. 6 illustrates a prototype of the floor material recognition system shown in FIG. 4.

The first controller 111 may be implemented as a computing device that at least includes a processor or a controller and/or a memory. The first controller 111 is indicated as a main computer in FIG. 5. For example, the first controller 111 may be implemented using Jetson Nano.

The second controller 112 may be implemented as a sensor board (function generator/analog-to-digital converter module (FAM)) to operate the object recognition device 120. Also, the third controller 113 may be implemented as a control board (electronic control unit (ECU)) that controls driving of the floor material recognition system.

In the implementation example of FIG. 5, if a driving signal is received, the floor material recognition system (i.e., mobile robot) moves at a predetermined speed (e.g., speed of 10 cm/s) for a predetermined period of time (e.g., 4 seconds). The second controller (FAM) 112 may supply an alternating voltage of 200V amplitude with an offset voltage of 200V as a signal for operating the actuator, thereby allowing the actuator of the object recognition device 120 to vibrate. That is, an actuator signal may represent an alternating voltage with a predetermined amplitude. Here, the transmitted alternating voltage may cause frequency sweeping within the predetermined range (e.g., from 100 Hz to 1 kHz) for a predetermined period of time (e.g., approximately 2.3 seconds). The second controller 112 may receive sensor data transmitted from the object recognition device 120 at a predetermined sampling frequency (e.g., sampling frequency of 25 kHz), and receiving the sensor data may be terminated simultaneously when the actuator signal ends. Through this process, the first controller 111 may collect 57,687 data points per driving and sensor signal.

When collecting a sensor signal, elements that affect the sensor signal may be classified into two as shown in FIG. 6. First, if a mechanical vibration generated by the actuator is transmitted to the sensor through the floor, a signal is generated due to the piezoelectric effect. Second, if a PVDF film of each of the actuator and the sensor performs the electrode role and the floor performs the dielectric role, the capacitance effect is induced between two electrodes, so an electrical signal generates a sensor signal. Therefore, the sensor signal contains both a signal induced due to the mechanical vibration of the actuator and a signal due to the capacitance effect between two PVDF films.

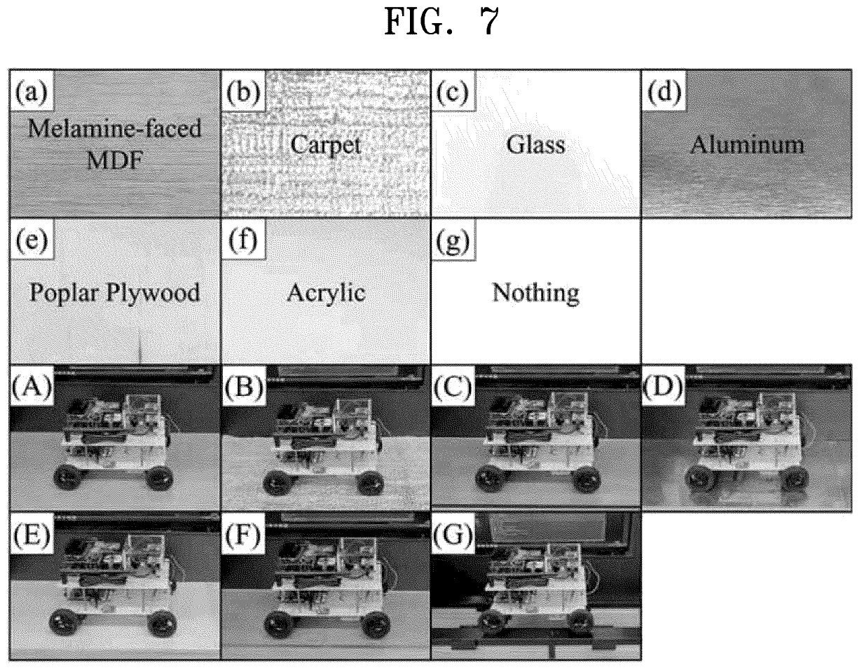

FIG. 7 illustrates a case in which no contact is made with six floor materials selected to conduct a floor material identification test with a test execution method according to an example embodiment of the present invention. Therefore, sensor data according to a plurality of (e.g., seven) floor materials may be collected. However, it is obvious that the scope of the present invention is not limited to types or the number of floor materials.

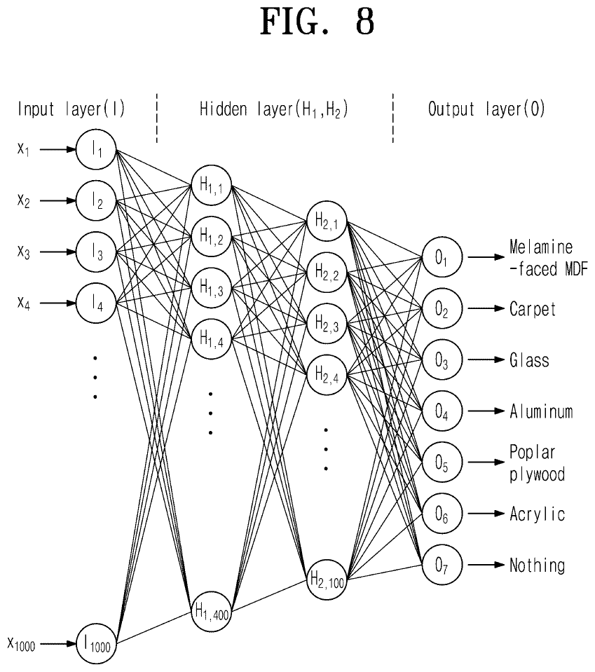

FIG. 8 illustrates an exemplary structure of a floor material recognition model according to an example embodiment of the present invention.

The floor material recognition model may represent a model based on an artificial neural network (ANN). In total, 1,680 pieces of processed data were acquired by conducting 240 experiments for each floor condition and used to train the artificial neural network model. The artificial neural network may include a multilayer perceptron layer, and input and hidden layers may have the size of 1,000-400-100. Here, to prevent overfitting, a scale of dropout layers may be set to 0.2 and an L2 regularizer with a regularization rate of 0.002 may be used. This artificial neural network structure is performed for 4,000 epochs and, if overfitting tends to appear after 1,000 epochs, training is stopped. 1,680 pieces of data were used for training, test, and validation data at a ratio of 4:1:1, and data is randomly assigned every training.

### Embodiment

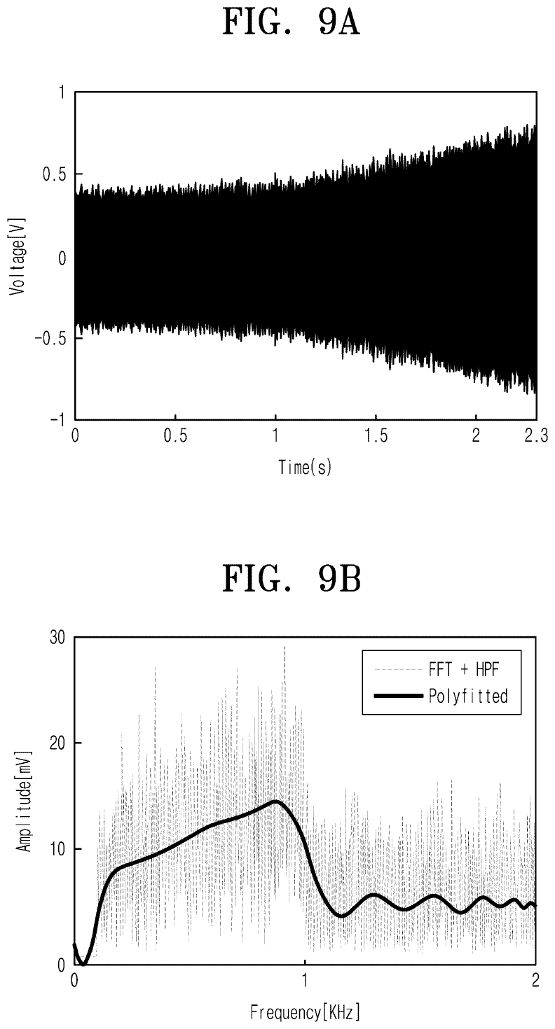

FIG. 9A is a graph showing sensor data acquired from an object recognition device as a change in voltage over time according to an example embodiment of the present invention. This sensor data is used to generate input data of an artificial neural network using Fourier transform, a high pass filter, and polyfitting as shown in FIG. 9B. A green line within the graph of FIG. 9B represents data that has passed a polyfitting process, and this data may be used as the input data.

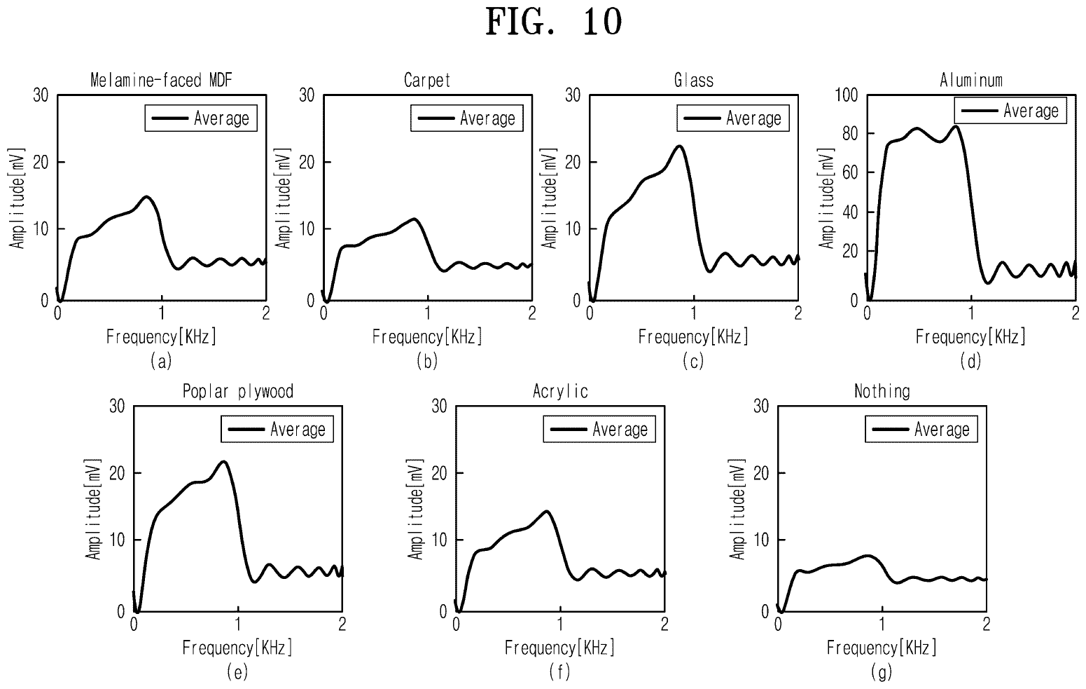

FIG. 10 illustrates graphs each showing sensor data and frequency spectrum according to each floor material used in an artificial neural network model according to an example embodiment of the present invention, and shows graphs each in which 240 pieces of data processed for each floor state are collected in one graph. In each graph of FIG. 10, a red line represents the average spectrum of 240 pieces of data.

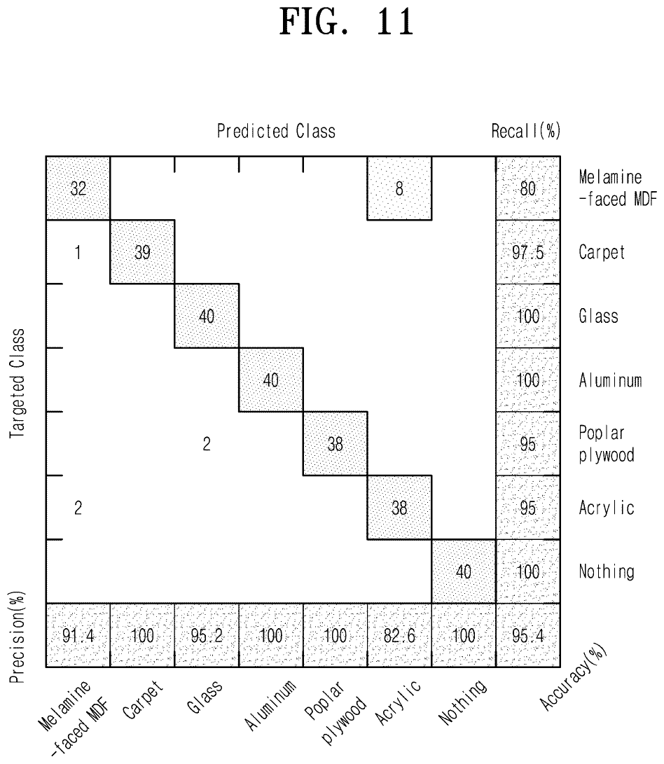

FIG. 11 is a graph showing a classification confusion matrix of a trained artificial neural network model according to an example embodiment of the present invention. That is, FIG. 11 shows the confusion matrix in which a total of 1,680 pieces of data were randomly mixed, divided into training, test, and validation data at a ratio of 4:1:1, used to train the proposed artificial neural network. Referring to FIG. 11, it can be seen that the proposed floor material recognition system smoothly operates with the accuracy of 95.4%.

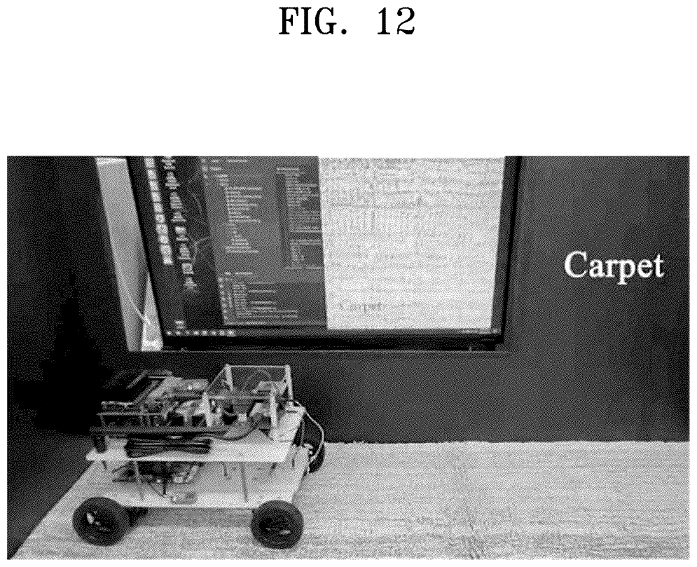

FIG. 12 is a photo showing an example in which a trained floor material recognition model is mounted to a floor material recognition system and an actual mobile robot determines a floor material while driving according to an example embodiment of the present invention. Through this, it can be verified that the proposed system may be used in real life.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

Although the present invention is described with reference to the example embodiments illustrated in the drawings, it is provided as an example only and it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A floor material recognition system comprising:
a control unit configured to control an operation of the floor material recognition system; and
an object recognition device configured to generate a mechanical vibration in response to an actuator signal received from the control unit and to generate a sensor signal corresponding to the mechanical vibration,
wherein the control unit recognizes a material on the floor surface present in a movement path of the floor material recognition system based on the sensor signal.

2. The floor material recognition system of claim 1, wherein the object recognition device includes:
a substrate;
an actuator and a sensor formed on the substrate; and
a protective film formed on the actuator and the sensor,
the actuator is configured to generate the mechanical vibration in response to the actuator signal,
the sensor is configured to generate the sensor signal, and
the protective film of the object recognition device is configured to come into contact with the floor during movement of the floor material recognition system.

3. The floor material recognition system of claim 2, wherein one surface of the substrate on which the actuator and the sensor are not formed is attached to a panel coupled to a suspensor mounted on the bottom surface of the floor material recognition system, such that the object recognition device comes into contact with the floor with a predetermined force applied.

4. The floor material recognition system of claim 3, wherein the substrate of the object recognition device is a polyethylene terephthalate (PET) substrate in a rectangular shape,
the actuator and the sensor are provided on the other surface of the substrate to be in contact with each other,
each of the actuator and the sensor is a polyvinylidene fluoride (PVDF) film,
the actuator has a rectangular shape of which one side not in contact with the sensor is cut in a rectangular shape,
the sensor has a rectangular shape of which one side not in contact with the actuator is cut in a rectangular shape, and
the protective film is a Kapton tape.

5. The floor material recognition system of claim 4, wherein the actuator signal is an alternating voltage in which frequency is swept for a predetermined time duration within a predetermined frequency range.

6. The floor material recognition system of claim 5, wherein the control unit includes:
a first controller configured to generate and output a first control signal; and
a second controller configured to transmit the actuator signal to the object recognition device in response to the first control signal, to acquire the sensor signal from the sensor, and to transmit the acquired sensor signal to the first controller.

7. The floor material recognition system of claim 6, wherein the first controller is configured to generate input data by performing a preprocessing operation on the acquired sensor signal, and to recognize the material on the floor surface by inputting the input data to a pretrained floor material recognition model.

8. The floor material recognition system of claim 7, wherein the preprocessing operation includes:
a signal transformation operation of transforming the acquired sensor signal that is a signal of a time domain to a signal of a frequency domain,
an operation of removing noise included in the signal transformed to the signal of the frequency domain, and
an operation of generating the input data by polyfitting the signal in which noise is removed, and
the floor material recognition model is a model trained based on an artificial neural network (ANN).

9. The floor material recognition system of claim 8, wherein the first controller is configured to output a second control signal for controlling movement of the floor material recognition system, and
the control unit includes a third controller configured to output a driving signal for controlling a driving unit that is included in the floor material recognition system to generate a driving force, in response to the second control signal.

10. The floor material recognition system of claim 9, wherein the object recognition device is attached to the panel of which both ends are rounded.
